(19) United States
(12) Patent Application Publication
(10) Pub. No.: US 2005/0175422 A1
(43) Pub. Date: Aug. 11, 2005

(54) MILLING CUTTER HAVING CLOSE HOLDING EFFECT

(76) Inventor: Sin Tian Jhang, Taiping City (TW)

Correspondence Address: CHARLES E. BAXLEY, ESQ., 90 JOHN STREET, THIRD FLOOR, NEW YORK, NY, 10038, US

(21) Appl. No.: 10/772,458

(22) Filed: Feb. 6, 2004

(51) Int. Cl. B23C 5/22

(52) U.S. Cl. 407/54

(57) ABSTRACT

A milling cutter, comprising a cutter body, a cutter holder secured on the cutter body, a cutting insert secured on the cutter holder, and a locking screw extended through the cutter holder and the cutting insert to combine the cutter holder and the cutting insert. Thus, when the locking screw is screwed on the cutter holder, the elastic clamp of the cutter holder is urged to move toward the fixing seat, so that the clamping jaw of the elastic clamp is closely urged on the first end of the cutting insert and the clamping face of the elastic clamp is closely urged on a second end of the cutting insert, thereby locking the cutting insert on the cutter holder rigidly and stably.

### BACKGROUND OF THE INVENTION

1. Field of the Invention

The present invention relates to a milling cutter, and more particularly to a milling cutter having a close holding effect.

2. Description of the Related Art

A conventional milling cutter in accordance with the prior art shown in FIGS. 6-11 comprises a cutter body 10 having a cutter holder 11 formed with a receiving recess 111, a cutting insert 12 mounted in the receiving recess 111 of the cutter holder 11 and formed with a shaft hole 121, and a locking screw 13 extended through the cutter holder 11 and the shaft hole 121 of the cutting insert 12 to combine the cutter holder 11 and the cutting insert 12.

As shown in FIG. 8, the cutting insert 12 has thickness t smaller than the width d of the receiving recess 111 of the cutter holder 11. Thus, the cutting insert 12 is clamped in the receiving recess 111 of the cutter holder 11 by elastic deformation of the distal end of the cutter holder 11.

As shown in FIG. 9, the cutting insert 12 is only supported by the clamping force of the distal end of the cutter holder 11, so that the cutting insert 12 is not mounted on the cutter holder 11 rigidly and stably, thereby affecting the cutting precision of the milling cutter.

As shown in FIGS. 10 and 11, during operation of the conventional milling cutter, the cutting insert 12 is subjected to a resistance “F” which produces a moment “M” which produces a rotational force on the cutting insert 12, so that the cutting insert 12 is easily rotated by the moment “M” to change its position. Thus, when the cutting insert 12 is subjected to a shearing stress the cutting size of the cutting insert 12 is easily changed, and the cutting insert 12 is easily broken.

### SUMMARY OF THE INVENTION

The present invention is to mitigate and/or obviate the disadvantage of the conventional milling cutter.

The primary objective of the present invention is to provide a milling cutter having a close holding effect.

Another objective of the present invention is to provide a milling cutter, wherein the clamping jaw of the elastic clamp is fixed in the fixing groove of the cutting insert, so that the cutting insert is fixed on the cutter holder by support of the clamping jaw of the elastic clamp and cannot be moved axially and rotated relative to the cutter holder.

A further objective of the present invention is to provide a milling cutter, wherein when the locking screw is screwed on the cutter holder, the elastic clamp of the cutter holder is urged to move toward the fixing seat, so that the clamping jaw of the elastic clamp is closely urged on the first end of the cutting insert and the clamping face of the elastic clamp is closely urged on a second end of the cutting insert, thereby locking the cutting insert on the cutter holder rigidly and stably.

A further objective of the present invention is to provide a milling cutter, wherein the locking screw is combined with the cutter holder and the cutting insert in a close fit manner, so that the cutting insert is fixed on the cutter holder by support of the locking screw and cannot be moved axially and rotated relative to the cutter holder.

A further objective of the present invention is to provide a milling cutter, wherein the cutting insert is mounted on the cutter holder rigidly and stably, so that the cutting resistance applied on the cutting insert is distributed on the cutter holder evenly, thereby preventing the cutting insert from being worn out or broken.

A further objective of the present invention is to provide a milling cutter, wherein the locking screw is combined with the cutter holder and the cutting insert in a close fit manner, so that the cutting insert is fixed on the cutter holder by support of the locking screw and cannot be moved sideward relative to the cutter holder.

In accordance with the present invention, there is provided a milling cutter, comprising a cutter body, a cutter holder secured on one end of the cutter body, a cutting insert secured on the cutter holder, and a locking screw extended through the cutter holder and the cutting insert to combine the cutter holder and the cutting insert, wherein:
the cutter holder has an inside formed with a receiving recess, the receiving recess of the cutter holder has a first side formed with an elastic clamp and a second side formed with a fixing seat, the elastic clamp of the cutter holder has a first end formed with an elongated slit, a mediate portion formed with an elongated arcuate protruding clamping jaw, and a second end formed with a depression formed with a clamping face; and
the cutting insert is mounted in the receiving recess of the cutter holder and has a first end formed with an elongated arcuate fixing groove mounted on the clamping jaw of the elastic clamp and a second end urged by the clamping face of the elastic clamp.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a milling cutter in accordance with the preferred embodiment of the present invention;

FIG. 2 is a plan assembly view of the milling cutter as shown in FIG. 1;

FIG. 3 is a plan assembly view of the milling cutter as shown in FIG. 1;

FIG. 4 is a partially cross-sectional enlarged view of the milling cutter as shown in FIG. 3;

FIG. 5 is a partially cross-sectional enlarged view of the milling cutter as shown in FIG. 2;

FIG. 6 is an exploded perspective view of a conventional milling cutter in accordance with the prior art;

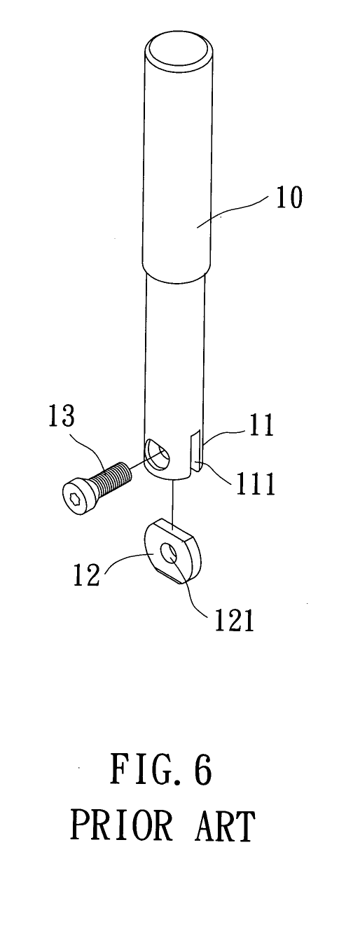

FIG. 7 is a plan assembly view of the conventional milling cutter as shown in FIG. 6;

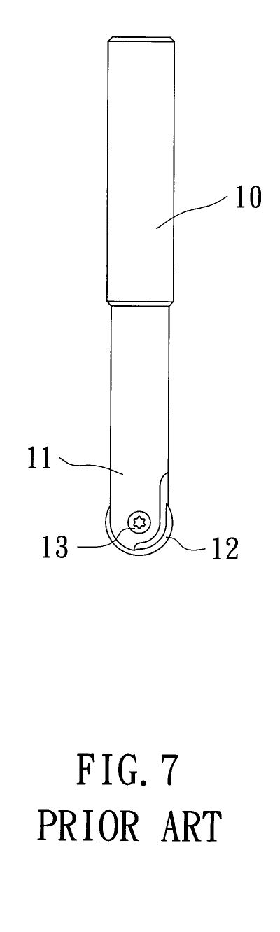

FIG. 8 is a plan view of the conventional milling cutter as shown in FIG. 6;

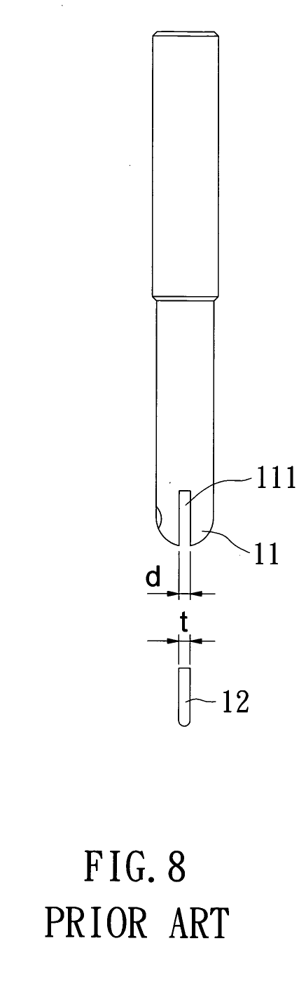

FIG. 9 is a partially plan enlarged view of the conventional milling cutter as shown in FIG. 6;

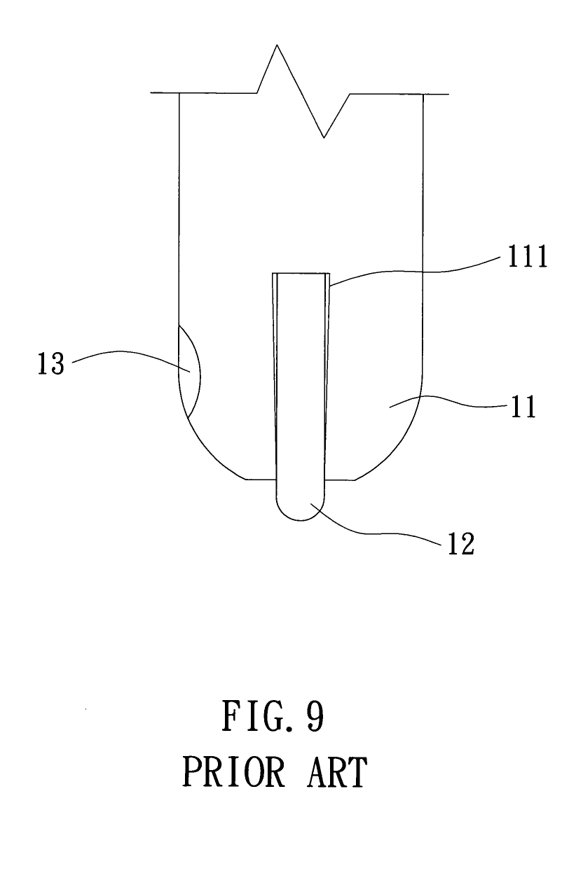

FIG. 10 is a schematic operational view of the conventional milling cutter as shown in FIG. 7; and

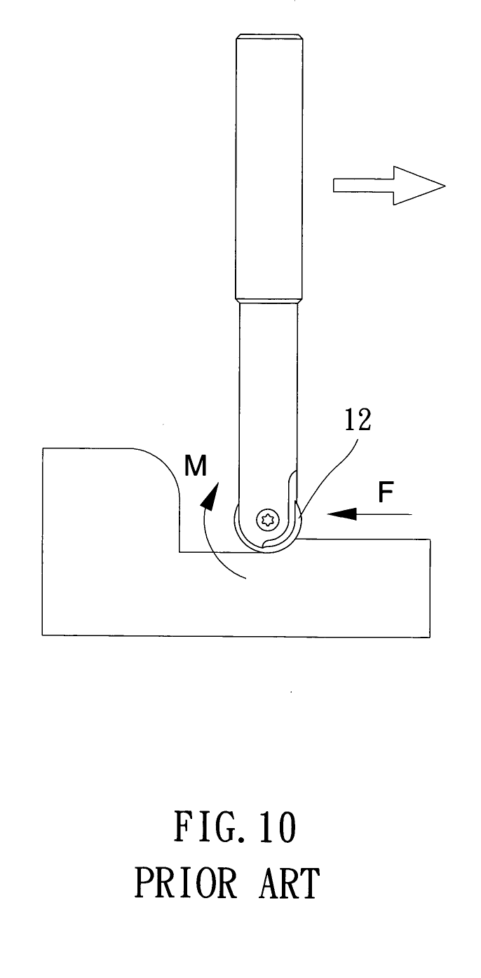

FIG. 11 is a schematic operational view of the conventional milling cutter as shown in FIG. 7.

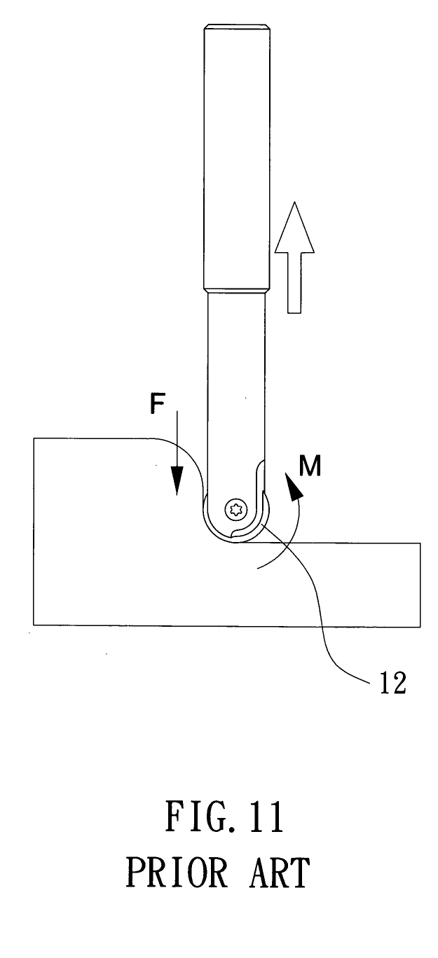

### DETAILED DESCRIPTION OF THE INVENTION

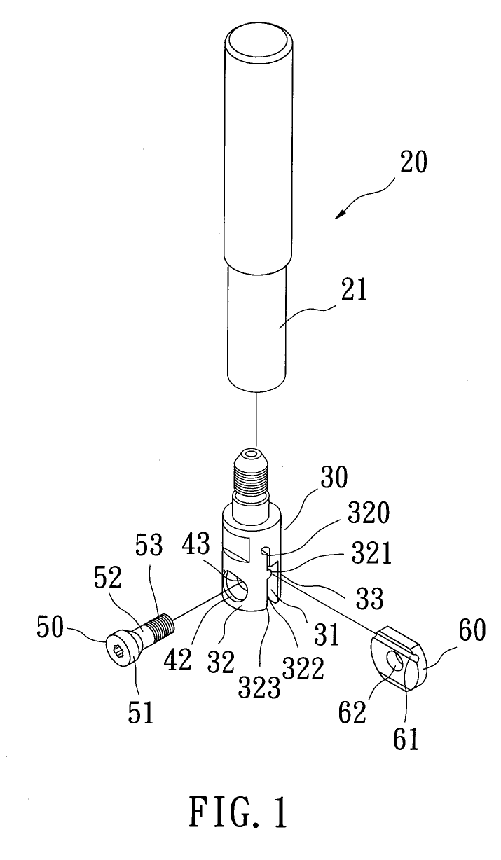

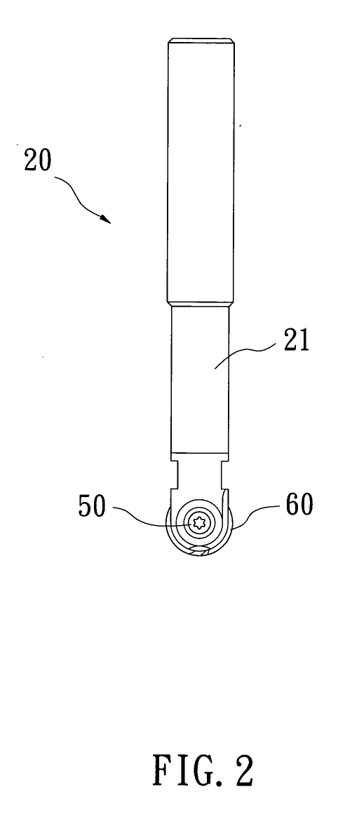

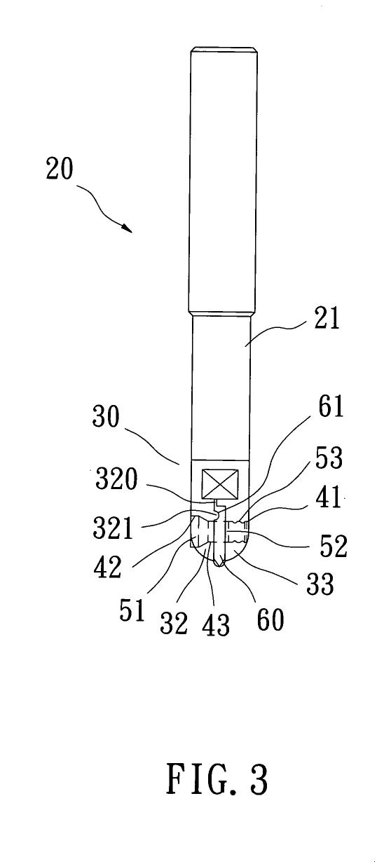

Referring to the drawings and initially to FIGS. 1-4, a milling cutter 20 in accordance with the preferred embodiment of the present invention comprises a cutter body 21, a cutter holder 30 secured on one end of the cutter body 21, a cutting insert 60 secured on the cutter holder 30, and a locking screw 50 extended through the cutter holder 30 and the cutting insert 60 to combine the cutter holder 30 and the cutting insert 60.

The cutter holder 30 has an inside formed with a receiving recess 31. The receiving recess 31 of the cutter holder 30 has a first side formed with an elastic clamp 32 and a second side formed with a fixing seat 33. The elastic clamp 32 of the cutter holder 30 has a first end formed with an elongated slit 320 communicating with the receiving recess 31 of the cutter holder 30 so that the elastic clamp 32 of the cutter holder 30 has an elastic deformation effect. The elastic clamp 32 of the cutter holder 30 has a mediate portion formed with an elongated arcuate protruding clamping jaw 321. The elastic clamp 32 of the cutter holder 30 has a second end formed with a depression 322 formed with a clamping face 323. The elastic clamp 32 of the cutter holder 30 has an inside formed with a countersunk bore 42, the fixing seat 33 of the cutter holder 30 has an inside formed with a screw bore 41, and the cutter holder 30 is formed with a support hole 43 communicating with the countersunk bore 42 and the screw bore 41. Preferably, the support hole 43 of the cutter holder 30 is extended to the elastic clamp 32 and the fixing seat 33.

The cutting insert 60 is mounted in the receiving recess 31 of the cutter holder 30 and has a first end formed with an elongated arcuate fixing groove 61 mounted on the clamping jaw 321 of the elastic clamp 32 and a second end urged by the clamping face 323 of the elastic clamp 32. The cutting insert 60 has a mediate portion formed with a through hole 62.

Preferably, a clearance is defined between the receiving recess 31 of the cutter holder 30 and the first end of the cutting insert 60, thereby preventing the cutting insert 60 from being worn out or broken.

In practice, the clamping jaw 321 of the elastic clamp 32 is extended in a direction vertical to an axial direction of the receiving recess 31 of the cutter holder 30, and the fixing groove 61 of the cutting insert 60 is extended in a direction the same as that of the clamping jaw 321 of the elastic clamp 32. Thus, the cutting insert 60 is sideward inserted into the receiving recess 31 of the cutter holder 30, and the clamping jaw 321 of the elastic clamp 32 slides into the fixing groove 61 of the cutting insert 60.

The locking screw 50 includes a shank 52 extended through the countersunk bore 42 of the elastic clamp 32, the support hole 43 of the cutter holder 30, the through hole 62 of the cutting insert 60 and the screw bore 41 of the fixing seat 33, a head 51 formed on a first end of the shank 52 and fixed in the countersunk bore 42 of the elastic clamp 32, and an outer thread 53 formed on a second end of the shank 52 and screwed into the screw bore 41 of the fixing seat 33.

Preferably, the head 51 of the locking screw 50 is worked by a grinding process to have an exact size, and a small tolerance (about 0.01 mm) is defined between the head 51 of the locking screw 50 and the countersunk bore 42 of the elastic clamp 32. In addition, the shank 52 of the locking screw 50 is worked by a grinding process to have an exact size, and a small tolerance (about 0.01 mm) is defined between the shank 52 of the locking screw 50 and the support hole 43 of the cutter holder 30. In addition, a small tolerance (about 0.01 mm) is defined between the shank 52 of the locking screw 50 and the through hole 62 of the cutting insert 60.

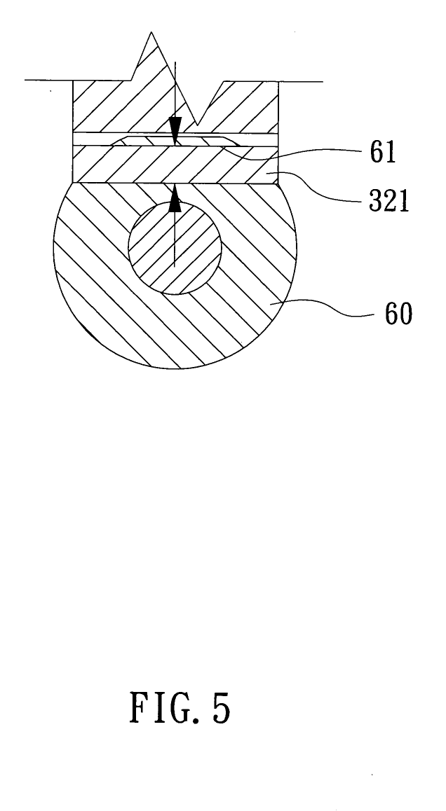

Accordingly, the clamping jaw 321 of the elastic clamp 32 is fixed in the fixing groove 61 of the cutting insert 60 as shown in FIG. 5, so that the cutting insert 60 is fixed on the cutter holder 30 by support of the clamping jaw 321 of the elastic clamp 32 and cannot be moved axially and rotated relative to the cutter holder 30.

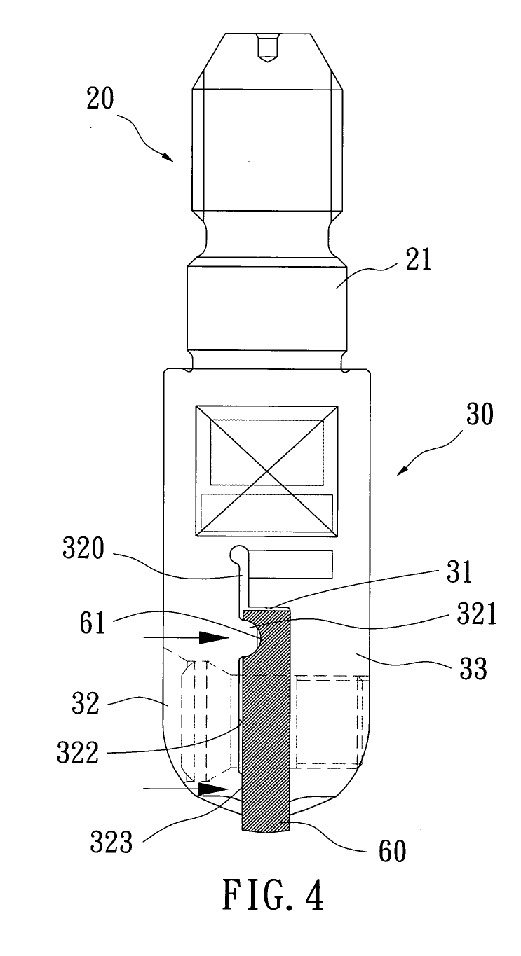

In addition, when the locking screw 50 is screwed on the cutter holder 30, the elastic clamp 32 of the cutter holder 30 is urged to move toward the fixing seat 33, so that the clamping jaw 321 of the elastic clamp 32 is closely urged on the first end of the cutting insert 60 and the clamping face 323 of the elastic clamp 32 is closely urged on the second end of the cutting insert 60 as shown in FIG. 4, thereby locking the cutting insert 60 on the cutter holder 30 rigidly and stably.

Further, the locking screw 50 is combined with the cutter holder 30 and the cutting insert 60 in a close fit manner, so that the cutting insert 60 is fixed on the cutter holder 30 by support of the locking screw 50 and cannot be moved axially and rotated relative to the cutter holder 30.

Further, the cutting insert 60 is mounted on the cutter holder 30 rigidly and stably, so that the cutting resistance applied on the cutting insert 60 is distributed on the cutter holder 30 evenly, thereby preventing the cutting insert 60 from being worn out or broken.

Further, the locking screw 50 is combined with the cutter holder 30 and the cutting insert 60 in a close fit manner, so that the cutting insert 60 is fixed on the cutter holder 30 by support of the locking screw 50 and cannot be moved sideward relative to the cutter holder 30.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A milling cutter, comprising-a cutter body, a cutter holder secured on one end of the cutter body, a cutting insert secured on the cutter holder, and a locking screw extended through the cutter holder and the cutting insert to combine the cutter holder and the cutting insert, wherein:
the cutter holder has an inside formed with a receiving recess, the receiving recess of the cutter holder has a first side formed with an elastic clamp and a second side formed with a fixing seat, the elastic clamp of the cutter holder has a first end formed with an elongated slit, a mediate portion formed with an elongated arcuate protruding clamping jaw, and a second end formed with a depression formed with a clamping face; and
the cutting insert is mounted in the receiving recess of the cutter holder and has a first end formed with an elongated arcuate fixing groove mounted on the clamping jaw of the elastic clamp and a second end urged by the clamping face of the elastic clamp.

2. The milling cutter in accordance with claim 1, wherein the elongated slit communicates with the receiving recess of the cutter holder so that the elastic clamp of the cutter holder has an elastic deformation effect.

3. The milling cutter in accordance with claim 1, wherein the elastic clamp of the cutter holder has an inside formed with a countersunk bore, the fixing seat of the cutter holder has an inside formed with a screw bore, and the cutter holder is formed with a support hole communicating with the countersunk bore and the screw bore, the cutting insert has a mediate portion formed with a through hole, and the locking screw includes a shank extended through the countersunk bore of the elastic clamp, the support hole of the cutter holder, the through hole of the cutting insert and the screw bore of the fixing seat, a head formed on a first end of the shank and fixed in the countersunk bore of the elastic clamp, and an outer thread formed on a second end of the shank and screwed into the screw bore of the fixing seat.

4. The milling cutter in accordance with claim 3, wherein the support hole of the cutter holder is extended to the elastic clamp and the fixing seat.

5. The milling cutter in accordance with claim 3, wherein the head of the locking screw is worked by a grinding process to have an exact size, and a small tolerance of about 0.01 mm is defined between the head of the locking screw and the countersunk bore of the elastic clamp.

6. The milling cutter in accordance with claim 3, wherein the shank of the locking screw is worked by a grinding process to have an exact size, and a small tolerance of about 0.01 mm is defined between the shank of the locking screw and the support hole of the cutter holder.

7. The milling cutter in accordance with claim 3, wherein a small tolerance of about 0.01 mm is defined between the shank of the locking screw and the through hole of the cutting insert.

8. The milling cutter in accordance with claim 1, wherein a clearance is defined between the receiving recess of the cutter holder and the first end of the cutting insert.

9. The milling cutter in accordance with claim 1, wherein the clamping jaw of the elastic clamp is extended in a direction vertical to an axial direction of the receiving recess of the cutter holder.

10. The milling cutter in accordance with claim 1, wherein the fixing groove of the cutting insert is extended in a direction the same as that of the clamping jaw of the elastic clamp.

11. The milling cutter in accordance with claim 1, wherein the cutting insert is sideward inserted into the receiving recess of the cutter holder, and the clamping jaw of the elastic clamp slides into the fixing groove of the cutting insert.
